(19) United States
(12) Patent Application Publication
(10) Pub. No.: US 2026/0241362 A1
(43) Pub. Date: Aug. 20, 2026

(54) CONTINUOUS FLOW PHOTOCATALYTIC REACTOR AND PHOTOCHEMICAL CONTINUOUS CONVERSION METHOD OF GAS

(71) Applicants: SAUDI ARABIAN OIL COMPANY, Dhahran (SA); KOREA ADVANCED INSTITUTE OF SCIENCE AND TECHNOLOGY, Daejeon (KR)

(72) Inventors: Hee-Tae JUNG, Daejeon (KR); Hyunju JUNG, Daejeon (KR); Issam GEREIGE, Thuwal (SA)

(21) Appl. No.: 19/130,511

(22) PCT Filed: Nov. 15, 2023
(86) PCT No.: PCT/KR2023/018402

§ 371 Date: May 15, 2025

(30) Foreign Application Priority Data
Nov. 15, 2022 (KR) 10-2022-0152182

(51) Int. Cl. B01J 19/12; B01J 19/00; B01J 19/08; B01J 19/24; C01B 32/40

(52) U.S. Cl. CPC B01J 19/123; B01J 19/0006; B01J 19/087; B01J 19/2475; C01B 32/40; B01J 2219/00033; B01J 2219/00164; B01J 2219/0801; B01J 2219/0803; B01J 2219/0869; B01J 2219/0884; B01J 2219/0892

(57) ABSTRACT

A photocatalytic reactor includes a first cell including a gas inlet and a gas outlet; a second cell including an electrolyte inlet and an electrolyte outlet; a reaction unit interposed between the first cell and the second cell and including a gas diffusion layer on which a photocatalyst or photo-electro-chemical catalyst is supported; and a light source, and can provide excellent long-term stability by greatly improving the production rate and durability of a product. In some cases, a voltage is applied across the catalyst to improve production rate.

### CLAIM OF PRIORITY

This application is a U.S. National Sate of PCT/KR2023/018402 filed on Nov. 15, 2023, which claims priority to Korean Patent Application No. 10-2022-0152182 filed on Nov. 15, 2022, the entire contents of which are hereby incorporated by reference.

### TECHNICAL FIELD

The present disclosure relates to a continuous flow photocatalytic reactor and a photochemical continuous conversion method of gas, and more specifically, to a continuous flow photocatalytic reactor and a photochemical continuous conversion method of gas with improved product production rate and long-term stability.

### BACKGROUND

As demand for eco-friendly alternative energy increases, fuel cells that can convert chemical energy into electric energy through an electrochemical reaction between hydrogen and oxygen are attracting attention. A gas diffusion electrode, which is usually used as an electrode in a fuel cell, includes a gas-phase reactant, a solid-phase electrode, and a liquid-phase electrolyte and can allow an electrode reaction to proceed while three phases coexist. An electrochemical reaction rate can be improved by causing a catalyst fixed on a porous membrane to interact with the electrolyte and gas.

In the related art, an electrocatalyst containing platinum has been usually used as a catalyst for a gas diffusion electrode. However, due to the high price of platinum, there were limitations to its application in various fields. In order to solve this problem, a photocatalyst has been proposed as an alternative.

In the case of a gas diffusion electrode including a conventional photocatalyst, a two-phase batch photocatalytic reactor has been used in which a solid photocatalyst reacts with a gas-phase or liquid-phase reactant. However, when the two-phase batch photocatalytic reactor is used, a reactant and a product may be adsorbed on a surface of the photocatalyst during an electrode reaction, deactivating the photocatalyst. Therefore, there is a problem in that production rate and long-term stability deteriorate.

For example, a gas-phase batch reactor is a closed system with no external flow, and mass transfer occurs only by diffusion. Therefore, a significant amount of product may remain on the surface of the photocatalyst without being desorbed. The residual product on the surface of the catalyst may hinder the reactant from occupying the surface of the catalyst, thereby lowering the production rate of the product.

Similarly, in a liquid-phase batch reactor as well, mass transfer mainly occurs by diffusion, so the product accumulates on the surface of the photocatalyst and can act as an obstacle to the reaction. In addition, a solution in which a reaction gas is saturated in a solvent is used as a reactant, so an amount of gas used in the reaction may be limited depending on the solubility of the reaction gas with respect to the solvent.

Therefore, in order to improve the reaction rate and long-term stability of the photocatalyst, research on photocatalytic reactors with high efficiency and high performance compared to batch reactors is needed.

### SUMMARY

The present disclosure has been made to solve the above problems of the related art, and can provide a photocatalytic reactor in which a production rate of a product is improved and a reactant and a product on a surface of a catalyst can be easily adsorbed and desorbed.

A photocatalytic reactor according to the present disclosure includes a first cell including a gas inlet and a gas outlet; a second cell including an electrolyte inlet and an electrolyte outlet; a reaction unit interposed between the first cell and the second cell and including a gas diffusion layer on which a photocatalyst is supported; and a light source.

In the photocatalytic reactor according to the present disclosure, in the first cell, a raw material gas can be supplied through the gas inlet, and a product gas can be discharged through the gas outlet.

In the photocatalytic reactor according to the present disclosure, in the second cell, the electrolyte inlet and the electrolyte outlet can be connected through a closed loop, so an electrolyte can be continuously supplied to the second cell.

In the photocatalytic reactor according to the present disclosure, the light source can be located on one side of the second cell so as to face the gas diffusion layer of the reaction unit.

In the photocatalytic reactor according to the present disclosure, the photocatalyst can be supported on a surface facing the second cell so as to be in contact with an electrolyte in the second cell.

In the photocatalytic reactor according to the present disclosure, the gas diffusion layer can include a hydrophobic membrane.

In the photocatalytic reactor according to the present disclosure, the hydrophobic membrane can be a porous hydrophobic membrane.

In the photocatalytic reactor according to the present disclosure, the hydrophobic membrane can be a porous polymer membrane or a porous ceramic membrane.

In the photocatalytic reactor according to the present disclosure, a gas in the first cell can diffuse into the gas diffusion layer, and the diffused gas can be converted into a product gas through the photocatalyst in contact with an electrolyte.

In the photocatalytic reactor according to the present disclosure, the first cell can have a higher pressure than that in the second cell.

In the photocatalytic reactor according to the present disclosure, the raw material gas can include carbon dioxide.

In the photocatalytic reactor according to the present disclosure, the product gas can include carbon monoxide.

In the photocatalytic reactor according to the present disclosure, the light source can irradiate light having an ultraviolet wavelength.

A method for photochemical continuous conversion of gas according to the present disclosure includes continuously supplying a raw material gas through a gas inlet of a first cell; continuously supplying an electrolyte through an electrolyte inlet of a second cell; and irradiating light to a gas diffusion layer on which a photocatalyst is supported, through one side of the second cell.

In the method for photochemical continuous conversion of gas according to the present disclosure, in the second cell, the electrolyte can be discharged through an electrolyte outlet and then re-supplied to the second cell through the electrolyte inlet via a closed loop.

In the method for photochemical continuous conversion of gas according to the present disclosure, in the first cell, the raw material gas can be converted into a product gas, which can be then discharged through a gas outlet located on one side of the first cell.

An apparatus according to the present disclosure includes a photocathode, a gas flow plate, an anode, an electrolyte flow plate, and a window. The photocathode includes a photo-electro-chemical catalyst. The gas flow plate is configured to receive a feed stream. The feed stream includes carbon dioxide. The gas flow plate defines a first aperture. The photocathode is disposed on the gas flow plate covering the first aperture. The first aperture allows the feed stream to come in contact with the photocathode. The photocathode and the anode are cooperatively configured to apply a voltage across the photo-electro-chemical catalyst in response to receiving an electric current. The electrolyte flow plate is configured to receive an electrolyte stream. The electrolyte stream includes an aqueous solution of dissolved salt. The electrolyte flow plate defines a second aperture aligned with the first aperture of the gas flow plate. The second aperture allows the electrolyte stream to come in contact with the photocathode. The photocathode is disposed intermediate of the first aperture of the gas flow plate and the second aperture of the electrolyte flow plate. The window is disposed on the electrolyte flow plate covering the second aperture opposite of the photocathode. The window is configured to prevent leakage of the electrolyte stream out of the second aperture of the electrolyte flow plate while allowing light from a light source to shine through the second aperture and onto the photocathode. The photo-electro-chemical catalyst is configured to lyse the carbon dioxide to produce carbon monoxide in response to the feed stream contacting the photocathode, the electrolyte stream contacting the photocathode, the anode and the photocathode applying the voltage across the photo-electro-chemical catalyst, and the light source shining light onto the photocathode.

The apparatus according to the present disclosure can include a gas flow control valve. The gas flow control valve can be configured to adjust a flow rate of a product gas exiting the gas flow plate. The product gas can include the produced carbon monoxide.

The apparatus according to the present disclosure can include a mass flowmeter. The mass flowmeter can be configured to measure a mass flow rate of the product gas exiting the gas flow plate. The gas flow control valve can be communicatively coupled to the mass flowmeter. The gas flow control valve can be configured to adjust the flow rate of the product gas exiting the gas flow plate at least based on the mass flow rate of the product gas measured by the mass flowmeter.

The apparatus according to the present disclosure can include a gas chromatography meter. The gas chromatography meter can be configured to determine a composition of the product gas exiting the gas flow plate. The gas flow control valve can be communicatively coupled to the gas chromatography meter. The gas flow control valve can be configured to adjust the flow rate of the product gas exiting the gas flow plate at least based on the composition of the product gas determined by the gas chromatography meter.

The apparatus according to the present disclosure can include a pump. The pump can be configured to circulate the electrolyte stream through the electrolyte flow plate.

A method according to the present disclosure includes flowing a feed stream into a gas flow plate. The feed stream includes carbon dioxide. The method according to the present disclosure includes flowing an electrolyte stream into an electrolyte flow plate. The electrolyte stream includes an aqueous solution of dissolved salt. A photocathode is disposed intermediate of the gas flow plate and the electrolyte flow plate. The photocathode includes a photo-electric-chemical catalyst. Flowing the feed stream into the gas flow plate and flowing the electrolyte stream into the electrolyte flow plate cause the feed stream and the electrolyte stream to come into contact with the photocathode at opposite sides of the photocathode. The method according to the present disclosure includes applying a voltage across the photo-electro-chemical catalyst. The method according to the present disclosure includes directing light onto the photo-electro-chemical catalyst. The method according to the present disclosure includes lysing, by the photo-electro-chemical catalyst, the carbon dioxide of the feed stream to produce carbon monoxide in response to the feed stream contacting the photocathode, the electrolyte stream contacting the photocathode, the voltage applied across the photo-electro-chemical catalyst, and the light directed onto the photo-electro-chemical catalyst.

In the method according to the present disclosure, a flow rate of a product gas exiting the gas flow plate can be measured. The product gas can include the produced carbon monoxide.

In the method according to the present disclosure, a composition of the product gas exiting the gas flow plate can be determined.

In the method according to the present disclosure, the flow rate of the product gas exiting the gas flow plate can be adjusted based on at least one of the measured flow rate or the determined composition.

In the method according to the present disclosure, the electrolyte stream exiting the electrolyte flow plate can be circulated back into the electrolyte flow plate.

The photocatalytic reactor according to the present disclosure is a continuous flow reactor and can control the pressure and flow of gas at the same time to allow a reactant and a product on a surface of the catalyst to be easily adsorbed and desorbed, leading to an improvement in production rate of the product.

Furthermore, it is possible to provide a photocatalytic reactor that can be easily applied to various types of photocatalysts.

### BRIEF DESCRIPTION OF DRAWINGS

FIG. 1 is a view showing a photocatalytic reactor according to the present disclosure.

FIG. 2 is a front view of the photocatalytic reactor according to the present disclosure.

FIG. 3 is a photograph view showing a continuous flow photocatalytic reactor according to an exemplary implementation of the present disclosure.

FIG. 4 is a view showing a photochemical reaction on a surface of a gas diffusion layer on which a photocatalyst is supported.

FIG. 5 is a view showing gas diffusion layers of an electrocatalytic reactor and a photocatalytic reactor.

FIGS. 6A, 6B, and 6C are graphs showing changes in production rates of methane (CH₄) and carbon monoxide (CO) according to changes in gas pressure (A), gas flow rate (B), and electrolyte flow rate (C) in a photocatalytic reactor according to an exemplary implementation of the present disclosure.

FIGS. 7A and 7B are graphs showing the production rates according to reaction time in a flow photocatalytic reactor (red), a liquid-phase batch reactor (blue), and a gas-phase batch reactor (black), in photocatalytic reactors according to Example of the present disclosure and Comparative Examples, in which (A) shows the production rates of methane (□) and carbon monoxide (○) according to reaction time, and (B) shows a ratio (C/C₀) of a total production to an initial value according to reaction time.

FIG. 8 is a view showing distributions of raw material gas and electrolyte molecules on surfaces of photocatalysts according to Example of the present disclosure and Comparative Examples.

FIGS. 9A, 9B, and 9C are graphs showing a gas chromatograph mass spectrometry (GC-MS chromatogram) and a mass spectrum on a product gas according to an isotope labeling method.

FIG. 10 is a graph showing the production rate of a product gas according to Examples of the present disclosure and Comparative Examples.

FIGS. 11A and 11B are a transmission electron microscopy (TEM) image and an X-ray diffraction (XRD) spectrum, respectively, of a platinum-titanium dioxide (Pt-P25) photocatalyst according to Example 10.

FIG. 12A is an exploded view of a schematic diagram of an example continuous flow photo-electric-catalytic reactor.

FIG. 12B includes a cross-sectional view and perspective view of an example of the continuous flow photo-electric catalytic reactor as assembled, whose schematic is shown in FIG. 12A.

FIG. 12C is an image of example layers including a photo-electrochemical catalyst, microporous layer, and microporous layer that can be included in the continuous flow photo-electric catalytic reactor of FIG. 12A.

FIG. 13A is an example graph illustrating the effect of applied current on the reaction(s) occurring in a continuous flow photo-electric-catalytic reactor.

FIG. 13B is an example graph illustrating the effect of cycled electrolyte flow rate on the production rate of a continuous flow photo-electric-catalytic reactor.

FIG. 13C is a schematic diagram illustrating the effect of cycled electrolyte flow rate on a surface of a photocathode of a continuous flow photo-electric-catalytic reactor.

FIG. 14A is an example graph illustrating the effect of applied carbon dioxide gas flow rate on the production rate of a continuous flow photo-electric-catalytic reactor.

FIG. 14B is an example graph illustrating the effect of pressure of the applied carbon dioxide gas on the production rate of a continuous flow photo-electric catalytic reactor.

FIG. 14C is a schematic diagram illustrating the effect of applied carbon dioxide gas flow rate on a surface of a photocathode of a continuous flow photo-electric-catalytic reactor.

FIG. 14D is a schematic diagram illustrating the effect of pressure of the applied carbon dioxide gas on a surface of a photocathode of a continuous flow photo-electric-catalytic reactor.

FIG. 15A is an example graph comparing faradaic efficiency and carbon monoxide production rates of an example hydrogen cell and an example continuous flow photo-electric-catalytic reactor with and without light irradiation.

FIG. 15B is a schematic diagram illustrating the reaction environment of an example hydrogen cell.

FIG. 15C is a schematic diagram illustrating the reaction environment of an example continuous flow photo-electric-catalytic reactor.

FIG. 16 is a schematic diagram of components of an example continuous flow photo-electric-catalytic reactor.

### DETAILED DESCRIPTION

The continuous flow photocatalytic reactor of the present disclosure will be described in detail. The terms used herein are selected, as much as possible, from common terms that are currently widely used, while considering the function of the present disclosure, which may vary depending on the intentions or precedents of engineers working in the relevant fields, the emergence of new technologies, and the like. Technical terms and scientific terms used herein may have the meaning understood by one skilled in the art to which the present disclosure pertains unless otherwise defined.

Terms such as “include”, “comprise”, or “have” used herein mean the presence of features or components described in the specification and do not preclude the possibility of adding one or more other features or elements in advance, unless specifically defined.

The singular forms such as ‘a', 'an', and 'the’ used herein are intended to include the plural forms as well, unless the context clearly indicates the singular forms. Further, the plural forms are intended to include the singular forms as well, unless the context clearly indicates the plural forms.

While such terms as “first”, “second”, and the like used herein may be used to describe various components, such components should not be limited to the terms. These terms are used only to distinguish one component from another.

In addition, numerical ranges used herein include a lower limit, an upper limit, and all values within that range, increments that are logically derived from the type and width of the defined range, all double-defined values, and all possible combinations of upper and lower limits of numerical ranges defined in different forms. Unless otherwise defined herein, values outside the numerical range that may arise due to experimental errors or rounded values are also included in the defined numerical range.

Terms “about” and the like used herein are meant to encompass tolerances when such tolerances are present.

A photocatalytic reactor according to the present disclosure includes a first cell including a gas inlet and a gas outlet; a second cell including an electrolyte inlet and an electrolyte outlet; a reaction unit interposed between the first cell and the second cell and including a gas diffusion layer on which a photocatalyst is supported; and a light source.

The photocatalytic reactor of the present disclosure can solve the limitations of the two-phase batch reactor of the related art. Unlike the two-phase batch reactor of the related art in which a large amount of product attaches to the surface of the catalyst and hinders the reactant gas from contacting the catalyst, the photocatalytic reactor of the present disclosure is a three-phase continuous flow reactor and is advantageous in that the raw material gas and hydrogen ions in the electrolyte can be supplied in abundance.

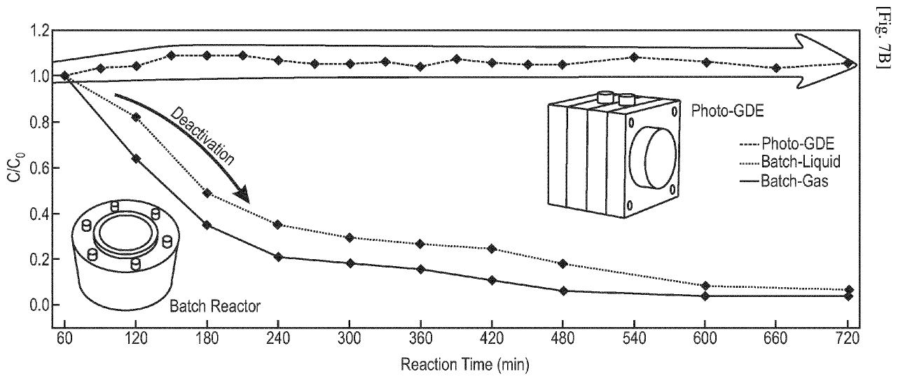

In a specific example, referring to FIG. 8, in the case of a liquid-phase batch reactor, the solubility of the raw material gas with respect to the solvent is limited, so an amount of the raw material gas that can react on the surface of the catalyst may be reduced.

In the case of a gas-phase batch reactor, the raw material gas can move and undergo the reaction only by diffusion of the raw material gas without external convection, so there may be a limit to an amount of the raw material gas that reaches the surface of the photocatalyst.

On the other hand, in the continuous flow photocatalytic reactor of the present disclosure, in the first cell, a raw material gas can be supplied through the gas inlet, and a product gas can be discharged through the gas outlet. The raw material gas in the first cell continuously supplied through the gas inlet can diffuse into the gas diffusion layer, and the diffused gas can be converted into a product gas through the photocatalyst in contact with an electrolyte. In the continuous flow photocatalytic reactor, the raw material gas can be continuously supplied, which can increase an amount of the raw material gas that is diffused to the surface of the photocatalyst, thereby increasing the production rate of the product gas.

In addition, since the raw material gas is continuously supplied, an amount of the raw material gas and product gas that are fixed on the surface of the photocatalyst can be reduced. In the case of the continuous flow photocatalytic reactor, compared to the liquid-phase and gas-phase batch reactors, a time for which the raw material gas stays on the surface of the photocatalyst can be shortened. Therefore, reactant and product molecules that strongly bind to the surface of the photocatalyst and act as catalyst poisons can be quickly desorbed from the photocatalyst, which can prevent the photocatalyst from being deactivated.

In an exemplary implementation, the photocatalytic reactor can include a reactor gas flow rate device including a gas pressure regulator, a flow control valve, and a mass flow meter (MFM).

In an exemplary implementation, the first cell can have a higher pressure than that in the second cell.

Specifically, the pressure of the raw material gas in the first cell can be 0.5 to 3.0 bar, 0.6 to 2.8 bar, 0.7 to 2.6 bar, 0.8 to 2.4 bar, or 0.9 to 2.2 bar, and preferably, can be set to 1.0 to 2.0 bar. Alternatively, the pressure can be 0.5 bar or higher, 0.6 bar or higher, 0.7 bar or higher, 0.8 bar or higher, 0.9 bar or higher, or 1.0 bar or higher, and an upper limit of the pressure of the raw material gas can be set to 3.0 bar or less, 2.8 bar or less, 2.6 bar or less, 2.4 bar or less, and 2.2 bar or less, or 2.0 bar or less.

If the raw material gas is supplied at a lower pressure than the above range, there is a risk that the electrolyte will overflow into the first cell, and if the raw material gas is supplied at a higher pressure than the above range, there may be a problem in that the raw material gas will flow into the second cell, forming bubbles in the electrolyte.

Applying pressure to the raw material gas is advantageous in that an amount of reactant that can pass through the gas diffusion layer and reach the photocatalyst to undergo the reaction can increase.

In an exemplary implementation, flow rates of the raw material gas and the electrolyte can be controlled using the flow control valve.

Since the pressure changes with changes in flow rate, it may be difficult to control the flow rate under a certain pressure. Therefore, while monitoring the flow rate with the mass flow meter in order to maintain the above-described pressure range at various flow rates, the pressure and the flow rate can be controlled simultaneously using the gas pressure regulator and the flow control valve to achieve the desired gas pressure and flow rate.

In the second cell, the electrolyte inlet and the electrolyte outlet can be connected through a closed loop, so the electrolyte can be continuously supplied to the second cell.

The raw material gas can diffuse in the first cell and reach the surface of the photocatalyst through the gas diffusion layer, and at the same time, the electrolyte can move to the surface of the photocatalyst in the second cell.

If the electrolyte inlet and electrolyte outlet of the second cell are of an open type, when a pressure of the raw material gas is higher than the atmospheric pressure, the raw material gas may leak into the electrolyte due to a pressure imbalance, forming bubbles in the electrolyte. Therefore, when the electrolyte inlet and the electrolyte outlet are configured in a closed loop and the electrolyte is supplied in the closed loop where it is easy to optimally set the pressure and flow rate of the raw material gas and the flow rate of the electrolyte, it is advantageous to improve the production rate.

The light source can be located on one side of the second cell so as to face the gas diffusion layer of the reaction unit.

Light generated from the light source can pass through the transparent electrolyte in the second cell and reach the surface of the photocatalyst. When light passes through the raw material gas in the first cell, the light should pass through the gas diffusion layer to reach the photocatalyst. However, the gas diffusion layer is opaque, so it may not be easy for the light having passed through the first cell to reach the photocatalyst and the electrolyte. Therefore, in order for light to quickly reach the surface of the photocatalyst, the light source is located on one side of the second cell including the transparent electrolyte, and the photocatalyst is supported on a side facing the second cell so that it comes into contact with the electrolyte in the second cell, which is advantageous because it is possible to efficiently irradiate the photocatalyst with light.

The gas diffusion layer can include a hydrophobic membrane. The hydrophobic membrane is a porous hydrophobic membrane, and raw material gas molecules in the first cell can pass through the hydrophobic membrane to reach the catalyst, but hydrophilic molecules such as an electrolyte cannot pass through the hydrophobic membrane.

Specifically, in the case of an electrocatalytic reactor, if an electrocatalytic reaction is repeatedly performed, the conductive hydrophobic membrane of the electrocatalytic reactor may be damaged and catalyst performance may deteriorate. In addition, the conductive hydrophobic membrane may act as a contaminant on a surface of the electrocatalyst and reduce an effective reaction area of the electrocatalyst.

Unlike the electrocatalytic reactor that activates the catalyst by applying electric energy to the catalyst, a photocatalytic reactor does not need to apply electric energy to the catalyst, so a non-conductive hydrophobic membrane can be used. Therefore, it is advantageous in securing long-term stability.

Additionally, the hydrophobic membrane of the photocatalytic reactor can have a thickness smaller than that of the hydrophobic membrane of the electrocatalytic reactor, so a movement path of the raw material gas can be shortened. The movement path of the reaction gas is shortened, allowing the raw material gas in the photocatalytic reactor to diffuse more quickly and efficiently into the photocatalyst.

The thickness of the hydrophobic membrane can be 80 to 200 μm, 90 to 180 μm, 100 to 160 μm, or 120 to 140 μm. Alternatively, the thickness of the hydrophobic membrane can be 80 μm or greater, 90 μm or greater, 100 μm or greater, 110 μm or greater, or 120 μm or greater, and an upper limit thereof can be 200 μm or less, 190 μm or less, 180 μm or less, 170 μm or less, 160 μm or less, 150 μm or less, or 140 μm or less, but the present disclosure is not limited thereto.

The hydrophobic membrane can be used without limitation as long as it is a porous polymer membrane or a porous ceramic membrane. For example, a porous polymer membrane such as polytetrafluoroethylene (PTFE; poly(1,1,2,2-tetrafluoroethylene)) can be used.

In an exemplary implementation, the raw material gas in the photocatalytic reactor can include carbon dioxide.

Specifically, a carbon dioxide reduction process can be performed through the photocatalytic reactor. A photocatalyst can generate electrons and holes by absorbing light irradiated from a light source. Charges generated by the photocatalyst can lead to a photochemical reduction reaction in which carbon dioxide is reduced on the surface of the photocatalyst. Carbon dioxide can be reduced to produce carbon monoxide as a product gas. The generated carbon monoxide can be discharged through a product gas outlet, but it should be noted that the present disclosure cannot be limited by the specific type of raw material gas.

As a non-limiting example, in addition to the carbon dioxide reduction reaction, a nitrogen reduction reaction may be performed using nitrogen as the raw material gas.

In an exemplary implementation, the photocatalyst can include one selected from the group consisting of titanium dioxide (TiO₂), zinc oxide (ZnO), carbon nitride (C₃N₄), cadmium sulfide (CdS), and platinum-titanium dioxide (Pt-P25) composite catalysts, but the present disclosure is not limited thereto.

Specifically, when the photocatalyst includes titanium dioxide (TiO₂), zinc oxide (ZnO), and platinum-titanium dioxide (Pt-P25) composite catalysts, it can have high reactivity for light in an ultraviolet band, and light having an ultraviolet wavelength can be irradiated by a light source. Likewise, when the photocatalyst includes carbon nitride (C₃N₄) or cadmium sulfide (CdS), it can have high efficiency when irradiating light in a visible light band by a light source.

The electrolyte can be used without limitation as long as it can be used in a general photo-electro-chemical reaction. For example, the electrolyte can include sodium bicarbonate (NaHCO₃) and potassium bicarbonate (KHCO₃), and preferably can include water (H2O), but the present disclosure is not limited thereto.

In detailing the method for photochemical continuous conversion of gas, the materials, structures, shapes, sizes, and the like of the first cell, the second cell, the gas diffusion layer, the photocatalyst, the light source, the raw material gas, and the electrolyte are the same as or similar to those of the photocatalytic reactor described above, so the photochemical continuous conversion method of gas according to the present disclosure includes all the contents previously described for the photocatalytic reactor.

A method for photochemical continuous conversion of gas according to the present disclosure includes continuously supplying a raw material gas through a gas inlet of a first cell; continuously supplying an electrolyte through an electrolyte inlet of a second cell; and irradiating light to a gas diffusion layer on which a photocatalyst is supported, through one side of the second cell.

The raw material gas can be continuously supplied through the gas inlet of the first cell, and at the same time, the electrolyte can be continuously supplied through the electrolyte inlet of the second cell.

The raw material gas supplied through the gas inlet can pass through the gas diffusion layer, diffuse to the surface of the catalyst, and come into contact with the electrolyte. At this time, the photocatalyst can generate charges by irradiating light to the gas diffusion layer on which the photocatalyst is supported. The raw material gas can be reduced by reaction among the charges generated from the photocatalyst, the raw material gas, and hydrogen ions of the electrolyte. When the raw material gas is converted into a product gas, the product gas can be discharged through a gas outlet located on one side of the first cell.

As the raw material gas is continuously supplied, an amount of the raw material gas diffusing to the surface of the photocatalyst increases, and a production rate of the product gas can be improved. In addition, rates at which the raw material gas and the product gas are adsorbed and desorbed on the surface of the photocatalyst increase, which is advantageous in preventing a phenomenon that the photocatalyst is deactivated due to accumulation of the raw material gas and product gas on the surface of the photocatalyst.

In the second cell, the electrolyte can be discharged through an electrolyte outlet and then re-supplied to the second cell through the electrolyte inlet via a closed loop.

The electrolyte inlet and electrolyte outlet are configured in a closed loop, so that the pressure and flow rate of the raw material gas and the flow rate of the electrolyte can be easily controlled. Therefore, optimized pressure and flow rate can be set, improving the production rate of the product gas and providing excellent stability.

In addition, it is advantageous in that it is possible to prevent a temperature of the electrolyte from excessively rising due to light irradiated from the light source as the electrolyte continuously flows through the closed loop.

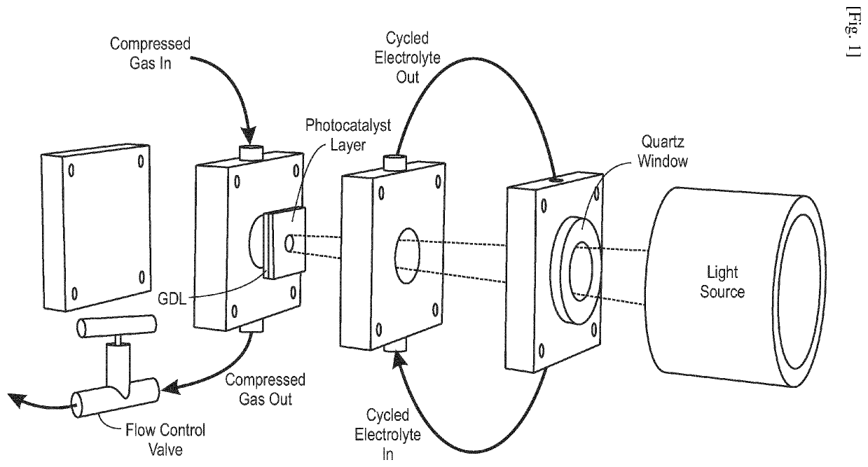

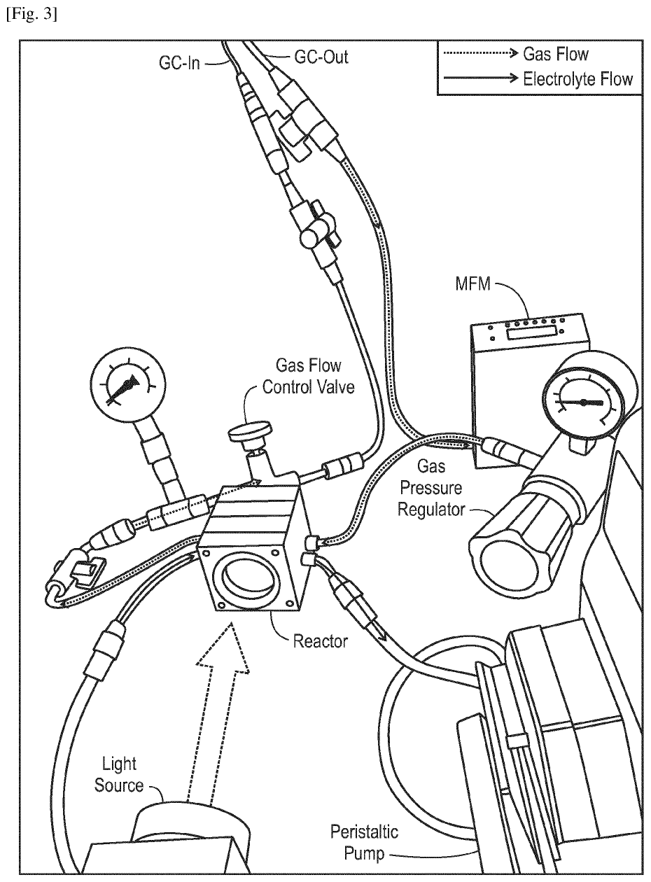

FIGS. 1 and 3 are views showing a photocatalytic reactor according to the present disclosure. The photocatalytic reactor can include a first cell, a gas diffusion layer, a photocatalyst, a second cell, and a light source.

All reactor plates can include stainless steel (SUS), which does not react with other chemicals during a photochemical reaction.

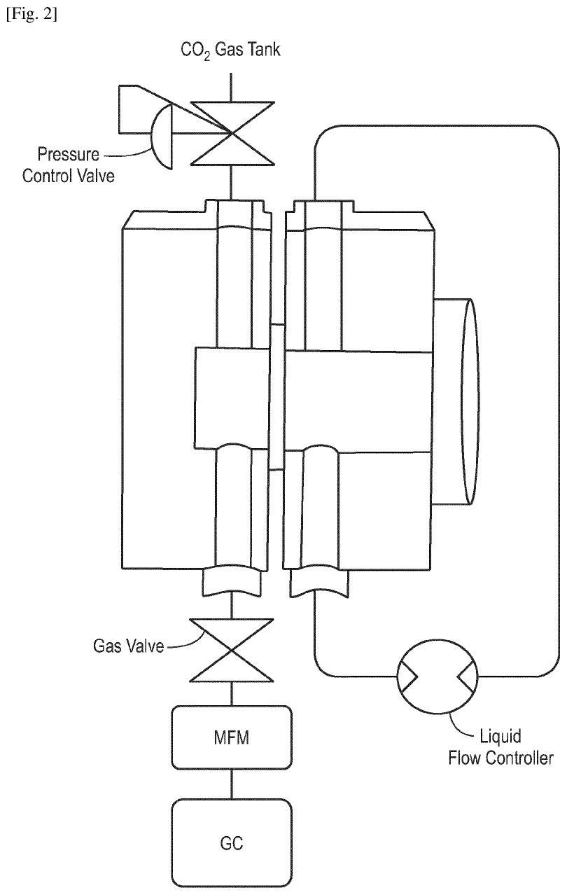

FIG. 2 is a front view of the photocatalytic reactor according to the present disclosure. The electrolyte inlet and outlet of the photocatalytic reactor include a closed loop, which is advantageous in that the photocatalyst can be in equilibrium with the high-pressure reaction gas.

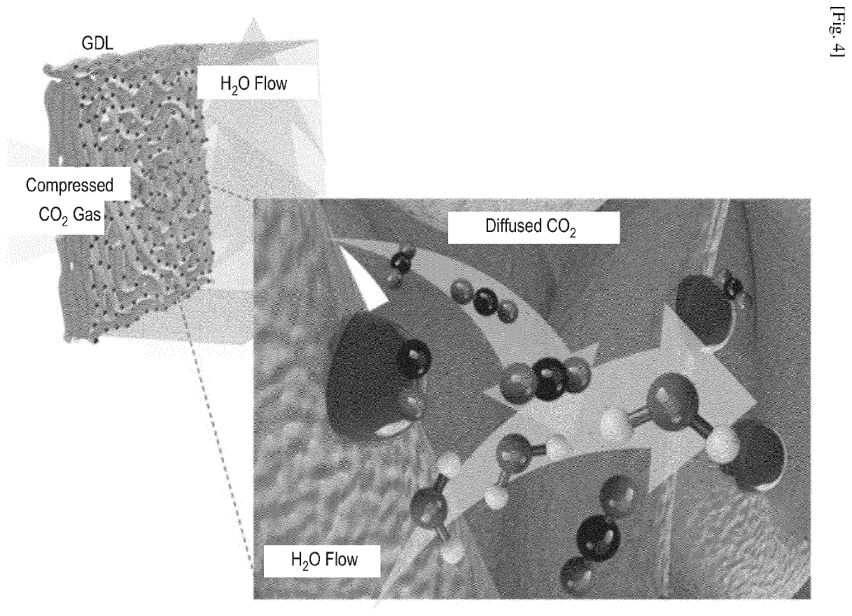

FIG. 4 is a view showing a reduction reaction on a surface of the gas diffusion layer on which the photocatalyst is supported. The raw material gas (CO₂) diffused through the gas diffusion layer from the first cell and the electrolyte (H₂O) can contact on the surface of the photocatalyst. The photocatalyst forms electrons and holes by light irradiated from the light source, and the electrons and holes, the raw material gas and the hydrogen ions generated from electrolyte undergo a redox reaction to generate carbon monoxide and methane, which are product gases.

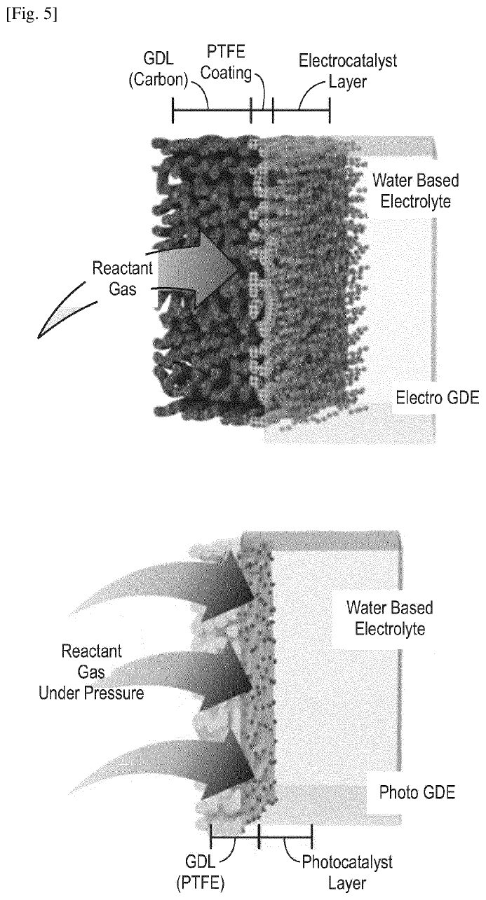

FIG. 5 is a view showing structures of an electrocatalytic reactor and a photocatalytic reactor. In the case of the electrocatalytic reactor, the reaction proceeds by applying electric energy to the catalyst, so the hydrophobic membrane should be conductive. However, in the case of the photocatalytic reactor of the present disclosure, the hydrophobic membrane does not need to be conductive, so the thickness of the hydrophobic membrane can be made thinner compared to that of the electrocatalyst. Additionally, in the case of the photocatalytic reactor, since the reaction proceeds by applying pressure to the raw material gas, the amount of raw material gas supplied to the catalyst can also be increased.

Hereinafter, certain implementations will be described in more detail through

### EXAMPLES

### Example 1

As shown in FIG. 3, a continuous flow photocatalytic reactor according to the present disclosure was installed. As the hydrophobic membrane, a polytetrafluoroethylene (PTFE; poly(1,1,2,2-tetrafluoroethylene)) film, a porous polymer membrane, was used. The thickness of the hydrophobic membrane was 130 μm.

A photocatalyst was formed on the hydrophobic membrane. The photocatalyst was dispersed in methanol using a Nafion solution (5 wt %), and the dispersed solution was spray coated on the hydrophobic membrane. A photochemical continuous carbon dioxide reduction reaction was performed using water as the electrolyte and carbon dioxide as the raw material gas. Titanium dioxide (TiO₂) was used as the photocatalyst, and a xenon (Xe) lamp with an intensity of 300 mW/cm² was used as a light source for irradiating light. The pressure of the raw material gas was 0.2 bar, the flow rate of the raw material gas was 10 sccm, and the flow rate of the electrolyte was 166 mL/min.

### Example 2

A photochemical continuous carbon dioxide reduction reaction was performed in the same manner as in Example 1, except that the pressure of the raw material gas was 0.5 bar.

### Example 3

A photochemical continuous carbon dioxide reduction reaction was performed in the same manner as in Example 1, except that the pressure of the raw material gas was 1.0 bar.

### Example 4

A photochemical continuous carbon dioxide reduction reaction was performed in the same manner as in Example 1, except that the flow rate of the raw material gas was 2 sccm.

### Example 5

A photochemical continuous carbon dioxide reduction reaction was performed in the same manner as in Example 1, except that the flow rate of the raw material gas was 5 sccm.

### Example 6

A photochemical continuous carbon dioxide reduction reaction was performed in the same manner as in Example 1, except that the flow rate of the raw material gas was 15 sccm.

### Example 7

A photochemical continuous carbon dioxide reduction reaction was performed in the same manner as in Example 1, except that the flow rate of the electrolyte was 47 mL/min.

### Example 8

A photochemical continuous carbon dioxide reduction reaction was performed in the same manner as in Example 1, except that the flow rate of the electrolyte was 85 mL/min.

### Example 9

A photochemical continuous carbon dioxide reduction reaction was performed in the same manner as in Example 1, except that the flow rate of the electrolyte was 335 mL/min.

### Example 10

A photochemical continuous carbon dioxide reduction reaction was performed in the same manner as in Example 1, except that a platinum-titanium dioxide synthesis catalyst was used as the photocatalyst.

### Example 11

A photochemical continuous carbon dioxide reduction reaction was performed in the same manner as in Example 1, except that zinc oxide was used as the photocatalyst.

### Example 12

A photochemical continuous carbon dioxide reduction reaction was performed in the same manner as in Example 1, except that carbon nitride was used as the photocatalyst.

### Example 13

A continuous photochemical carbon dioxide reduction reaction was performed in the same manner as in Example 1, except that cadmium sulfide was used as the photocatalyst.

### Comparative Example 1

A photochemical carbon dioxide reduction reaction was performed in the same manner as in Example 1, except that a gas-phase batch reactor with a volume of 50 mL was used.

### Comparative Example 2

A photochemical carbon dioxide reduction reaction was performed in the same manner as in Example 1, except that a liquid-phase batch reactor with a volume of 50 mL was used.

### Comparative Example 3

A photochemical continuous carbon dioxide reduction reaction was performed in the same manner as in Example 10, except that a batch reactor was used as the reactor.

### Comparative Example 4

A photochemical continuous carbon dioxide reduction reaction was performed in the same manner as in Example 11, except that a batch reactor was used as the reactor.

### Comparative Example 5

A photochemical continuous carbon dioxide reduction reaction was performed in the same manner as in Example 12, except that a batch reactor was used as the reactor.

### Comparative Example 6

A photochemical continuous carbon dioxide reduction reaction was performed in the same manner as in Example 13, except that a batch reactor was used as the reactor.

### (Experimental Example 1) Evaluation of Production Rate of Product Gas According to Pressure of Raw Material Gas

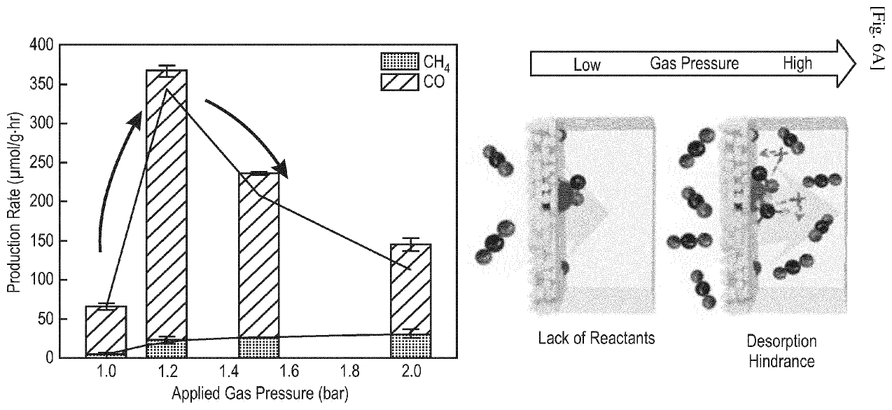

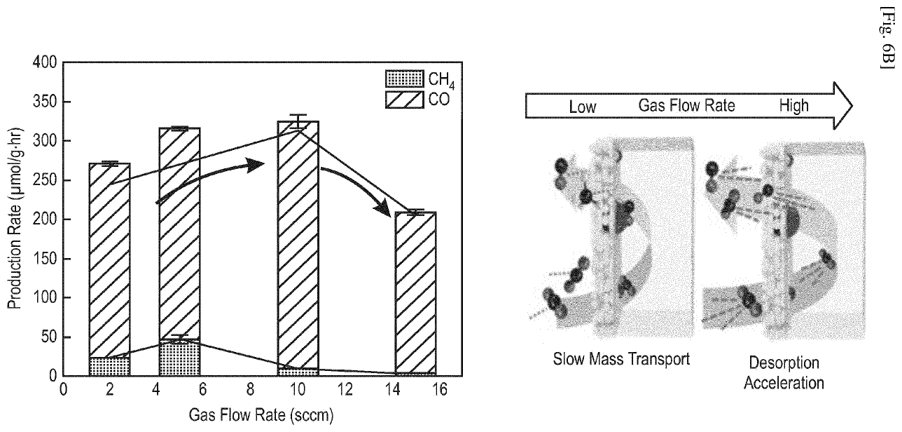

FIG. 6A shows the production rate of product gas at the time when the photochemical continuous carbon dioxide reduction reaction was performed using the methods of Examples 1 to 3.

As the pressure of carbon dioxide gas increases, the number of carbon dioxide molecules that pass through the gas diffusion layer and reach the photocatalyst increases, which can increase the production rate of the product gas. However, when the pressure of carbon dioxide gas increases above 0.2 bar, the production rate of carbon monoxide decreases, while the production rate of methane may slightly increase.

Due to the imbalance in adsorption and desorption of the raw material gas and the product gas, desorption may not be smooth, and the production rate of carbon monoxide may decrease.

As the pressure increases and the number of carbon dioxide molecules increases, the energy required to desorb product molecules from the surface of the catalyst may increase.

The desorption rate decreases, and additional reactions may occur on the non-desorbed carbon monoxide molecules on the surface of the catalyst to produce methane, so the production rate of methane may slightly increase.

### (Experimental Example 2) Evaluation of Production Rate of Product Gas According to Flow Rate of Raw Material Gas

FIG. 6B shows the production rate of product gas at the time when the photochemical continuous carbon dioxide reduction reaction was performed using the methods of Examples 1 and 4 to 6.

As the flow rate of the raw material gas increases, the production rate can also increase. The production rate of carbon monoxide reached the maximum value when the flow rate of the raw material gas was 10 sccm as in Example 1, and the production rate of carbon monoxide decreased in Example 6 in which the flow rate of the raw material gas increased above 10 sccm. In the case of methane, the production rate reached the maximum value in Example 5 in which the flow rate of the raw material gas was 5 sccm. The adsorption, photocatalytic reaction, and desorption can occur efficiently according to the flow rate value of the raw material gas.

As the flow rate increases, the residence time of the raw material gas in the reactor may decrease. Therefore, in Example 1 in which the flow rate of the raw material gas is 10 sccm, the photocatalytic reaction can occur most effectively, and when the flow rate is 10 sccm or more, the residence time of carbon dioxide molecules, which are the raw material gas, on the surface of the catalyst is not sufficient, so the adsorption, photocatalytic reaction, and product desorption may not occur effectively.

It indicates that the concentration of the final product and the selectivity of the reactant can be controlled by controlling the flow rate in the flow rate reactor system.

### (Experimental Example 3) Evaluation of Production Rate of Product Gas According to Flow Rate of Electrolyte

FIG. 6C shows the production rate of product gas at the time when the photochemical continuous carbon dioxide reduction reaction was performed using the methods of Examples 1 and 7 to 9.

The production rate increased as the electrolyte flow rate increased, and the production rate of product gas reached the maximum value in Example 1 in which the flow rate of the electrolyte was 166 mL/min, and the production rate of product gas may be reduced in Example 9 in which the flow rate of the electrolyte was larger than that in Example 1. As the flow rate of the electrolyte continuously supplied through the closed loop increases, the amount of the electrolyte on the surface of the catalyst can increase. Similar to Experimental Example 2, as the flow rate of the electrolyte increases, the residence time of water molecules, which are the electrolyte, decreases, making it difficult to effectively perform a role as a hydrogen donor. In Example 9, as the partial water pressure of the surface of the catalyst on the hydrophobic membrane increases, carbon dioxide molecules, which are the raw material gas, cannot pass through the hydrophobic membrane, and the supply of the raw material gas to the surface of the photocatalyst may be limited. Therefore, the raw material gas and the electrolyte may not sufficiently react on the surface of the photocatalyst, thereby reducing the production rates of carbon monoxide and methane.

### (Experimental Example 4) Evaluation of Production Rate of Product Gas According to Type of Reactor

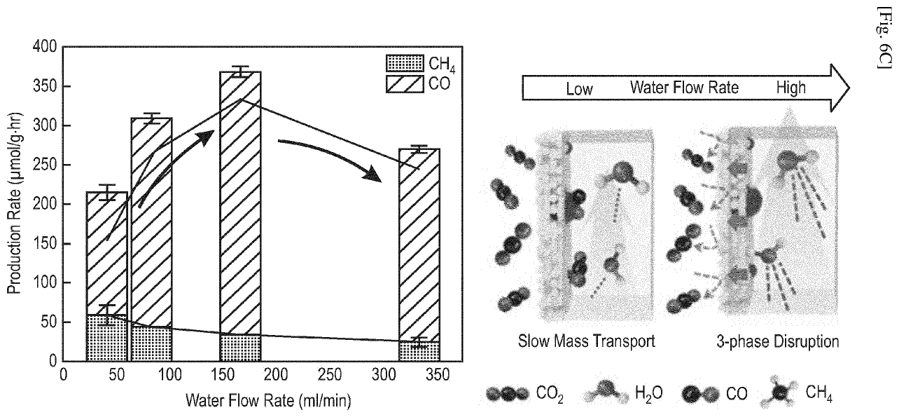

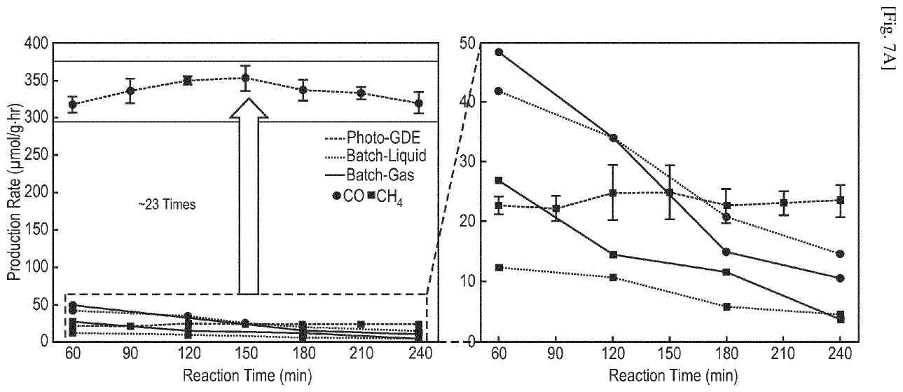

FIG. 7A shows the production rate of product gas at the time when the photochemical carbon dioxide reduction reaction was performed using the methods of Example 1, Comparative Example 1, and Comparative Example 2.

As shown in FIG. 7A, when the reaction time was 240 minutes, the production rate of carbon monoxide in Comparative Example 1 (black) was 10.6 μmol/g·h and the production rate of methane was 3.6 μmol/g·h, and the production rate of carbon monoxide in Comparative Example 2 (blue) was 14.5 μmol/g·h and the production rate of methane was 4.4 μmol/g·h. On the other hand, the production rate of carbon monoxide in the continuous flow photocatalytic reactor of Example 1 was 318 μmol/g·h and the production rate of methane was 11.2 μmol/g·h. That is, it can be confirmed that the production rate of carbon monoxide was 23 times higher than those of Comparative Examples 1 and 2.

In addition, while the carbon monoxide selectivity of Comparative Example 1 was 66.3% and the carbon monoxide selectivity of Comparative Example 2 was 77.1%, the continuous reactor of Example 1 may have high carbon monoxide selectivity of 93.4%. In Example 1, factors such as the pressure and flow rate of the raw material gas and the flow rate of the electrolyte can be precisely controlled. With this, it is possible to create a favorable environment in which the adsorption of reactant, the photochemical reaction, and the desorption of product can proceed smoothly on the surface of the photocatalyst. Therefore, carbon monoxide reduced from carbon dioxide, which is the raw material gas, can be quickly desorbed and discharged through the gas outlet before a subsequent reaction in which the reduced carbon monoxide is hydrogenated occurs.

It can be confirmed in FIG. 7B that in the case of the batch reactors of Comparative Example 1 and Comparative Example 2, when a long-term operation in which the reaction time is 240 minutes or longer is performed, the production rate of total products decreases sharply compared to the initial value of the photocatalyst. Specifically, after 180 minutes, the catalyst performance may decrease by 50% or more compared to the initial performance, after 480 minutes, the catalyst performance may decrease to less than 10% of the initial production rate, and after 720 minutes, only 5% of the initial performance may be maintained.

This decrease in catalyst performance may occur because as the reaction continues, the reactant and product fixed on the surface of the photocatalyst act as catalyst poison and deactivate the catalyst.

On the other hand, in the case of the continuous flow reactor of Example 1, high catalyst performance can be maintained even when the reaction lasts for 720 minutes. Therefore, the photocatalytic reactor of the present disclosure can provide excellent long-term stability by greatly improving the performance and durability of the photocatalyst.

### (Experimental Example 5) Evaluation of Distribution of Raw Material Gas and Electrolyte Molecules According to Type of Reactor

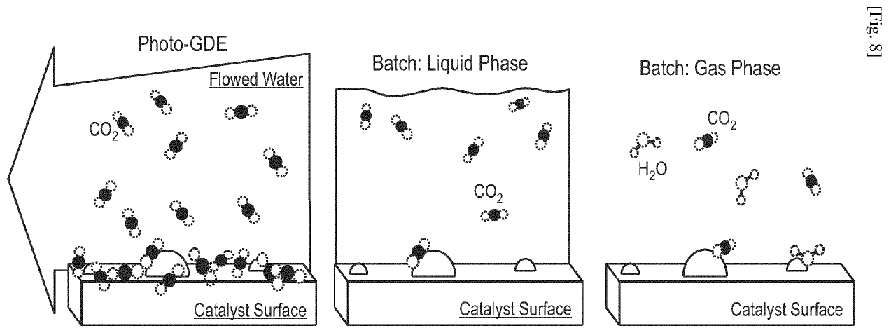

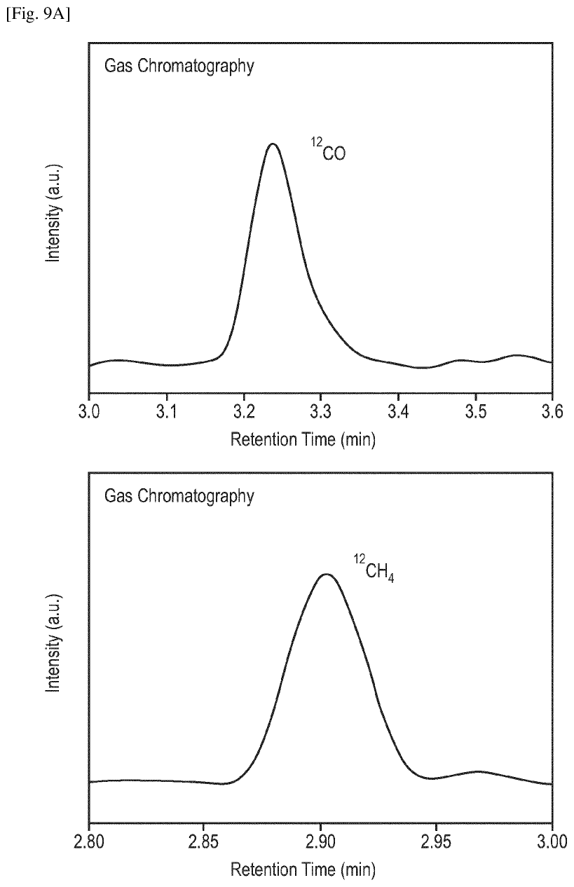

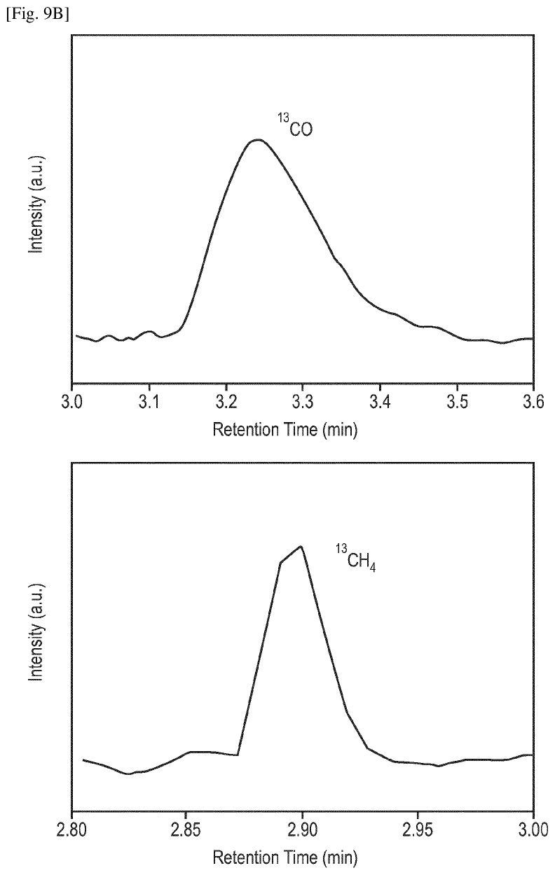

When performing the photochemical carbon dioxide reduction reaction by the method of Example 1, an isotope labeling test was performed through gas chromatography-mass spectrometry on the product gas, and results thereof are shown in FIGS. 9A, 9B, and 9C.

It can be confirmed in FIGS. 9A, 9B, and 9C that the raw material gas undergoes a reduction reaction and is converted into a product gas.

As a result of the gas chromatography, it can be confirmed that when carbon dioxide without isotope label was used as the raw material gas, ¹²CO and ¹²CH₄ were detected, and when isotope-labeled carbon dioxide (¹³CO₂) was used as the raw material gas, peaks in gas chromatography corresponding to ¹³CO and ¹³CH₄ could be detected. The peak in gas chromatography of carbon monoxide was detected at 3.24 minutes before methane, confirming that carbon monoxide was a main product.

Isotope-labeled carbon dioxide (¹³CO₂) was used as the raw material gas to perform the photochemical reaction of Example 1, and mass spectrometry on carbon monoxide and methane, which were the product gases, was performed.

The result of the isotope-labeled mass spectrometry shows that both types of product gases contain carbon, which is ¹³C, confirming that the product gases were produced from the raw material gas.

Specifically, a weak peak was observed at m/z=28, confirming that ¹²CO was contained, and a main peak was strongly detected at m/z=29, confirming that a large amount of ¹³CO was contained. Therefore, it can be confirmed that the carbon monoxide product was produced through photoreduction of carbon dioxide in the photocatalytic reactor of Example 1. Similarly, as a result of the mass spectrometry on methane, a peak was detected at m/z=17 corresponding to ¹³CH₄, indicating that it was a product by photoreduction of carbon dioxide.

### (Experimental Example 6) Evaluation of Production Rate of Product Gas According to Type of Photocatalyst

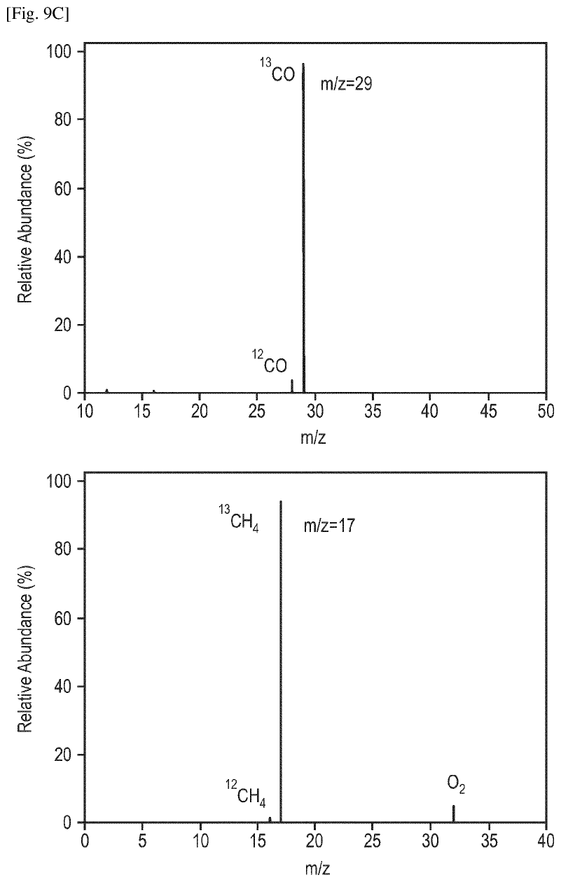

FIG. 10 shows the production rate of product gas at the time when the photochemical carbon dioxide reduction reaction was performed using the methods of Example 1, Examples 10 to Example 13, and Comparative Example 3 to 6.

When titanium dioxide (TiO₂, P25), zinc oxide (ZnO), and platinum-titanium dioxide (Pt-P25) composite catalysts were used as photocatalysts, light in the ultraviolet wavelength band was irradiated, and for carbon nitride (C₃N₄) and cadmium sulfide (CdS), light in the visible light band was irradiated while including a 300 nm cutoff filter in the light source.

As shown in FIG. 10, when the same photocatalyst was used, the continuous flow photocatalytic reactor of Examples 1 and 10 to 13 can exhibit a significantly superior production rate of 10 to 23 times, as compared with the production rate of product of Comparative Examples 3 to 6 in which the batch reactors were used.

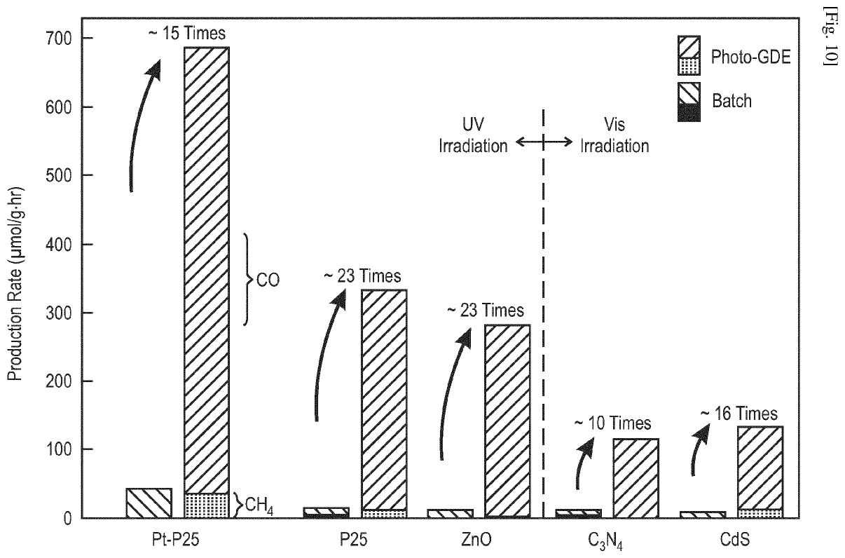

FIGS. 11A and 11B shows a transmission electron microscopy image and an X-ray diffraction spectrum of a platinum-titanium dioxide composite photocatalyst according to Example 6. It can be confirmed in FIGS. 11A and 11B that the platinum-titanium dioxide composite photocatalyst prepared by photodeposition was successfully formed.

The platinum-titanium dioxide composite photocatalyst can exhibit the highest production rate among the photocatalysts of Example 1 and 10 to 13 due to the significantly high conductivity of platinum.

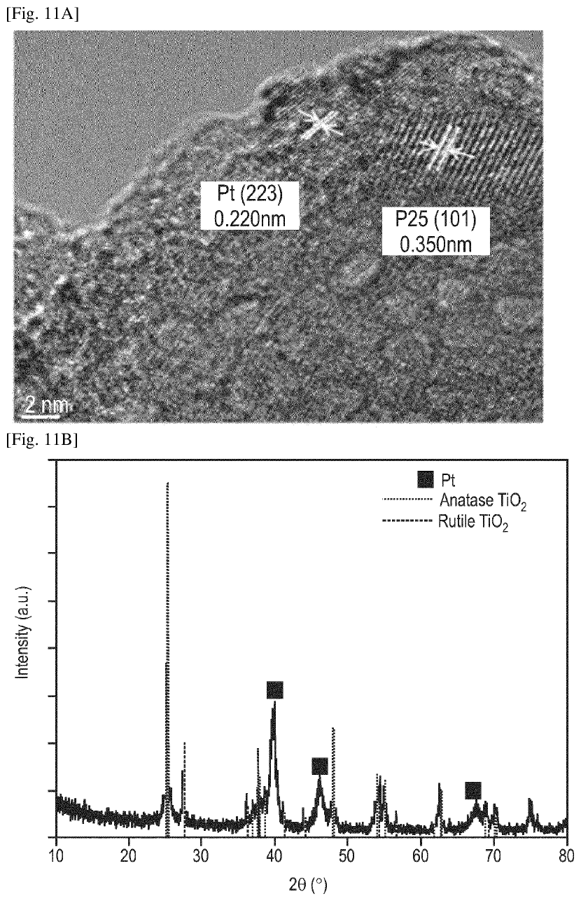

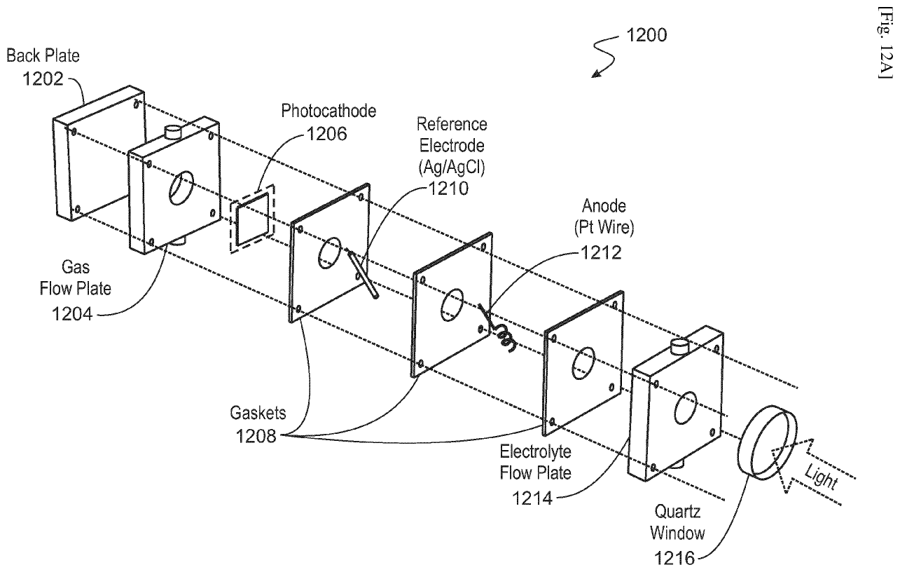

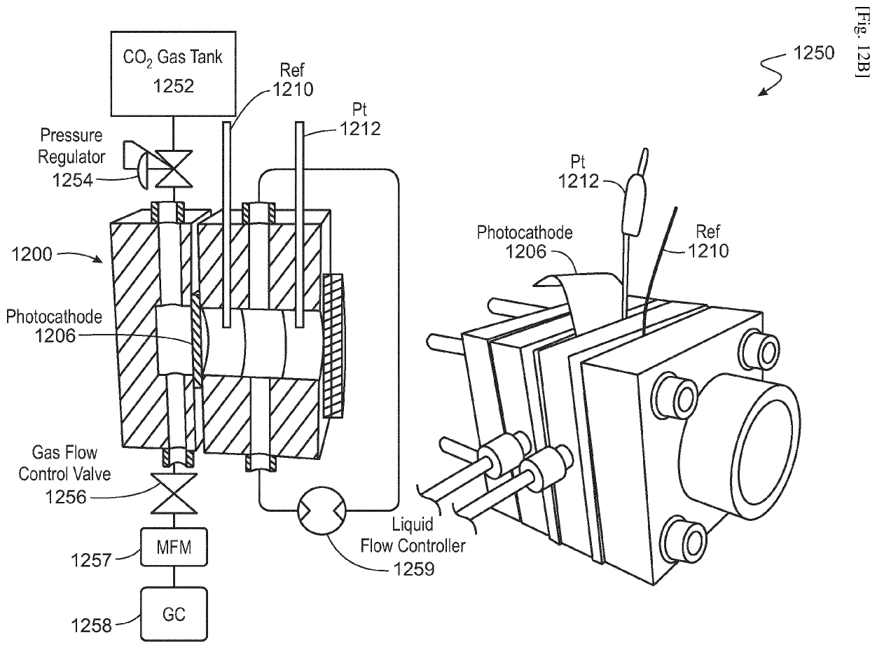

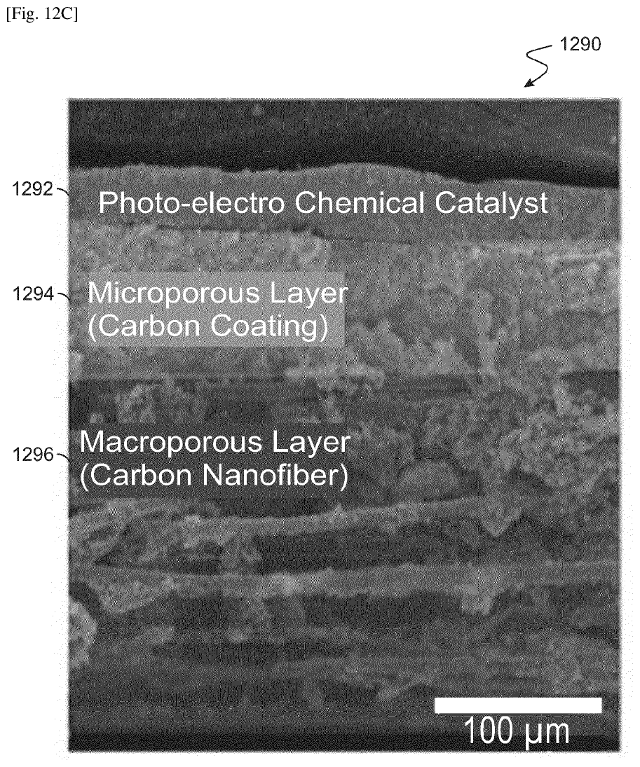

FIG. 12A is an exploded view of a schematic diagram of an example continuous flow photo-electric-catalytic reactor 1200. The reactor 1200 can be used to catalytically react a continuous feed stream (for example, including carbon dioxide) to produce a desired product (such as carbon monoxide). The reactor 1200 applies a voltage across a portion of the reactor 1200 to enhance the productivity (that is, production rate of the desired product) and maximize yield of the desired product. The reactor 1200 includes a back plate 1202, gas flow plate 1204, photocathode 1206, gaskets 1208, reference electrode 1210, anode 1212, electrolyte flow plate 1214, and window 1216. The back plate 1202 can provide support and stability to the reactor 1200. The gas flow plate 1204 includes an inlet and an outlet for a feed stream (reactant gas) to flow into and out of the gas flow plate 1204, respectively. The gas flow plate 1204 defines an aperture that allows the feed stream (flowing through the gas flow plate 1204) to come into contact with the photocathode 1206. The photocathode 1206 can include, for example, a photo-electro-chemical catalyst. The photocathode 1206 can be sized to cover an entirety of the aperture defined by the gas flow plate 1204 and sealed against the gas flow plate 1204 to prevent leaking of the feed stream out of the aperture. The gaskets 1208 are configured to secure components of the reactor 1200 together while also providing spacing between components. The reference electrode 1210 is electrically connected to the photocathode 1206. In some implementations, the reference electrode 1210 includes silver and/or silver chloride. The reference electrode 1210 is physically spaced apart from the photocathode 1206 by one of the gaskets 1208. The anode 1212 is electrically connected to the photocathode 1206 and the reference electrode 1210. In some implementations, the anode 1212 is a wire made, for example, from platinum. The anode 1212 is physically spaced apart from the reference electrode 1210 by one of the gaskets 1208. Electric current can be applied across the photocathode 1206, reference electrode 1210, and anode 1212 to enhance the productivity of the reactor 1200. The electrolyte flow plate 1214 includes an inlet and an outlet for an electrolyte stream to flow into and out of the electrolyte flow plate 1214, respectively. The electrolyte flow plate 1214 can be substantially similar in structure and shape to the gas flow plate 1204. The electrolyte flow plate 1214 defines an aperture that allows the electrolyte stream (flowing through the electrolyte flow plate 1214) to come into contact with the photocathode 1206. The window 1216 can be sized to cover an entirety of the aperture defined by the electrolyte flow plate 1214 and sealed against the electrolyte flow plate 1214 to prevent leaking of the electrolyte stream out of the aperture. The aperture defined by the electrolyte flow plate 1214 is aligned with the aperture defined by the gas flow plate 1204, so that light from a light source can shine through the window 1216 and the aperture defined by the electrolyte flow plate 1214 to the photocathode 1206. The components disposed between the gas flow plate 1204 and the window 1216 are either placed, such that the respective component does not fully obstruct the light shining through the window 1216 and through the aperture defined by the electrolyte flow plate 1214 to the photocathode 1206, or define a similar aperture (as the gas flow plate 1204 and the electrolyte flow plate 1214). In the example shown in FIG. 12A, each of the gaskets 1208 define apertures aligned with the apertures of the gas flow plate 1204 and the electrolyte flow plate 1214 because the gaskets 1208 are disposed between the gas flow plate 1204 and the window 1216. The apertures of the gaskets 1208 and the electrolyte flow plate 1214 allow for the electrolyte stream flowing through the electrolyte flow plate 1214 to come into contact with a first side of the photocathode 1206, while the aperture of the gas flow plate 1204 allows for the feed stream flowing through the gas flow plate 1204 to come into contact with a second side of the photocathode 1206, opposite of the first side. Light from a light source can shine through the window 1216 and apertures of the gaskets 1208 and the electrolyte flow plate 1214 and onto the photocathode 1206.

FIG. 12B is a cross-sectional view (left) and a perspective view (right) of a system 1250 that includes the continuous flow photo-electric catalytic reactor 1200, as assembled. The system 1250 includes a feed storage tank 1252. In this particular example, the feed storage tank 1252 holds carbon dioxide as feed to the reactor 1200, but in other implementations, the feed storage tank 1252 can hold a different feed having a composition other than just carbon dioxide (for example, a fluid mixture including carbon dioxide as one of its components, a fluid mixture not including carbon dioxide, or a fluid other than carbon dioxide). The feed stream flows from the storage tank 1252 to a pressure regulator 1254. The pressure regulator 1254 modulates the pressure of the feed flowing into the gas flow plate 1204. For example, the pressure regulator 1254 reduces the pressure of the feed stream prior to the feed stream entering the gas flow plate 1204. An electric current is supplied through the anode 1212, reference electrode 1210, and the photocathode 1206. The electric current applies a voltage across the anode 1212 and photocathode 1206 to facilitate reaction(s) in the reactor 1200. A liquid flow controller 1259 is configured to circulate the electrolyte stream through the electrolyte flow plate 1214. As such, the electrolyte stream flowing out of the electrolyte flow plate 1214 can be recirculated to the electrolyte flow plate 1214 by the liquid flow controller 1259. Within the gas flow plate 1204, the feed stream comes into contact with the photocathode 1206 via the aperture defined by the gas flow plate 1204. The electrolyte stream comes into contact with the photocathode 1206 via the aperture defined by the electrolyte flow plate 1214 and apertures of the gaskets 1208. The feed stream and the electrolyte stream contact the photocathode 1206 at opposite sides of the photocathode 1206. The interaction between the feed stream and the photocathode 1206, the interaction between the electrolyte stream and the photocathode 1206, the light shining through the window 1216 and onto the photocathode 1206, and the voltage applied across the photocathode 1206 and anode 1212 can facilitate reaction(s) to occur within the reactor 1200, such as lysis of carbon dioxide into carbon monoxide. In some cases, the application of the voltage applied across the photocathode 1206 and anode 1212 and the light shining onto the photocathode 1206 synergistically improve productivity (for example, accelerate the desired reaction(s)) of the reactor 1200. The gas flowing out of the gas flow plate 1204 includes carbon monoxide that was produced in the reactor 1200. The gas control valve 1256 is configured to control the flow rate of gas exiting the gas flow plate 1204. The gas control valve 1256 can be adjusted to maintain a desired space velocity of the feed stream in the gas flow plate 1204. For example, the gas control valve 1256 can adjust the flow rate of gas exiting the gas flow plate 1204, such that the feed stream entering the gas flow plate 1204 has sufficient time to contact the photocathode 1206 and convert into carbon monoxide before exiting the gas flow plate 1204. As another example, the gas control valve 1256 can adjust the flow rate of gas exiting the gas flow plate 1204, such that the feed stream entering the gas flow plate 1204 does not linger too long within the reactor 1200 to avoid converting into products other than carbon monoxide (such as methane) before exiting the gas flow plate 1204. In some implementations, the gas control valve 1256 adjusts the flow rate of gas exiting the gas flow plate 1204 for optimizing (for example, maximizing) the carbon monoxide content of the gas exiting the gas flow plate 1204. The mass flowmeter (MFM) 1257 measures a mass flow rate of the gas exiting the gas flow plate 1204. The gas chromatography meter 1258 can determine a composition of the gas exiting the gas flow plate 1204. In some implementations, the gas control valve 1256 is communicatively coupled to the mass flowmeter 1257, the gas chromatography meter 1258, or both. In some implementations, the gas control valve 1256 adjusts the flow rate of the gas exiting the gas flow plate 1204 at least based on the mass flow rate of the gas measured by the mass flowmeter 1257, the composition of the gas determined by the gas chromatography meter 1258, or both.

FIG. 12C is an image of an example of the photocathode 1206 including a photo-electro-chemical catalyst 1292, microporous layer 1294, and macroporous layer 1296 that can be included in the continuous flow photo-electric catalytic reactor 1200 of FIG. 12A. The photo-electro-chemical catalyst 1292 can be considered an “active” layer of the photocathode 1206 that accelerates at least one desired reaction in the reactor 1200, such as lysis of carbon dioxide to produce carbon monoxide. The microporous layer 1294 and macroporous layer 1296 can provide physical stability and strength for the photocathode 1206. The microporous layer 1294 and macroporous layer 1296 can also allow diffusion of molecules (for example, molecules of the electrolyte stream and/or molecules of the feed stream) through the layers 1294, 1296. In some implementations, the microporous layer 1294 includes a layer of carbon coating. In some implementations, the macroporous layer 1296 includes a layer of carbon nanofibers. In some implementations, the macroporous layer 1296 defines pores and/or pathways that are larger in size in comparison to those defined by the microporous layer 1294. In some implementations, the photo-electro-chemical catalyst 1292 is on the side of the photocathode 1206 that contacts the electrolyte stream from the electrolyte flow plate 1214, while the porous layers 1294, 1296 are on the side of the photocathode 1206 that contacts the feed stream from the gas flow plate 1204. In some implementations, the photo-electro-chemical catalyst 1292 is on the side of the photocathode 1206 that contacts the feed stream from the gas flow plate 1204, while the porous layers 1294, 1296 are on the side of the photocathode 1206 that contacts the electrolyte stream from the electrolyte flow plate 1214.

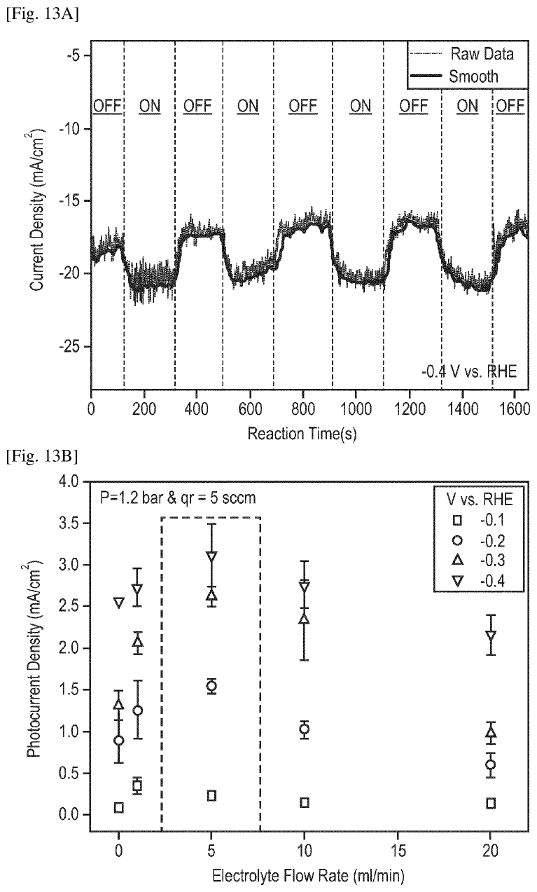

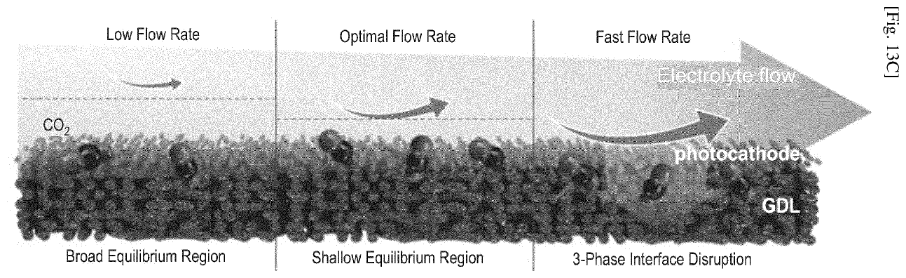

FIG. 13A is an example graph illustrating the effect of applied current on the reaction(s) occurring in the continuous flow photo-electric catalytic reactor 1200. The graph of FIG. 13A shows results of a chronoamperometric analysis of the photocathode 1206 at an applied voltage of −0.4 volts (V) vs. reversible hydrogen electrode (RHE). The regions of the graph of FIG. 13A labeled as “OFF” signify time durations of the experiment in which the light source was turned off, and light was not shining onto the photocathode 1206. The regions of the graph of FIG. 13A labeled as “ON” signify time durations of the experiment in which the light source was turned on, and light was shining onto the photocathode 1206.

FIG. 13B is an example graph illustrating the effect of cycled electrolyte flow rate on the production rate of the continuous flow photo-electric-catalytic reactor 1200. The graph of FIG. 13B shows results of experiments that varied electrolyte flow rate and applied voltage. The experiments included testing of the following electrolyte flow rates: 0 milliliters per minute (mL/min), 1 mL/min, 5 mL/min, 10 mL/min, and 15 mL/min. The experiments included testing of the following applied voltages: −0.1 V vs. RHE, −0.2 V vs. RHE, −0.3 V vs. RHE, and −0.4 V vs. RHE. The error bars shown in the graph of FIG. 13B signify the standard deviations from 3 replicated experiments. In these experiments, the optimum productivity was at an electrolyte flow rate of 5 mL/min and an applied voltage of −0.4 V vs. RHE.

FIG. 13C is a schematic diagram illustrating the effect of cycled electrolyte flow rate on a surface of the photocathode 1206 of the continuous flow photo-electric-catalytic reactor 1200. In FIG. 13C, the photo-electro-chemical catalyst 1292 and the gas diffusion layer (GDL, for example, the microporous layer 1294 and macroporous layer 1296) of the photocathode 1206 are shown. For the low electrolyte flow rate (left), the equilibrium region near the photocathode 1206 is broad, which can hinder productivity. For the optimal electrolyte flow rate (middle), the equilibrium region near the photocathode 1206 is shallow, which can improve productivity. For the fast electrolyte flow rate (right), the photocathode 1206 experiences 3-phase interface disruption, which can hinder productivity.

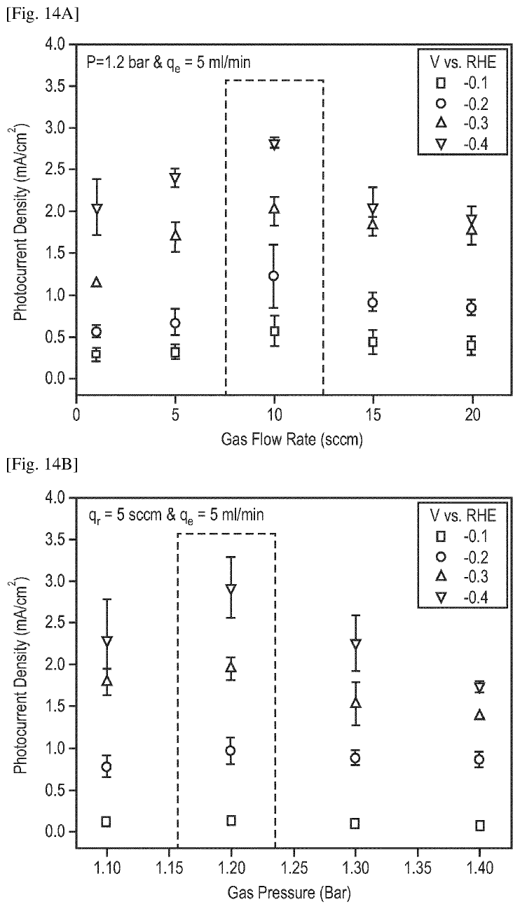

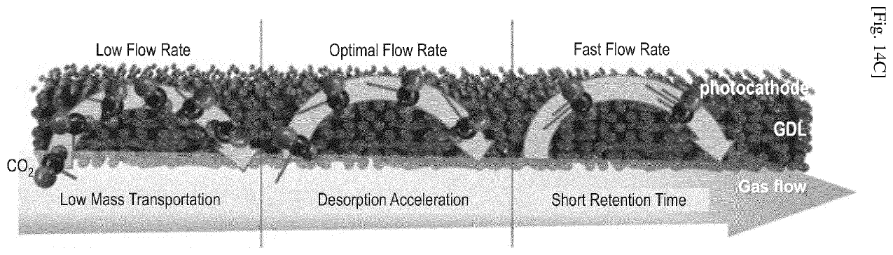

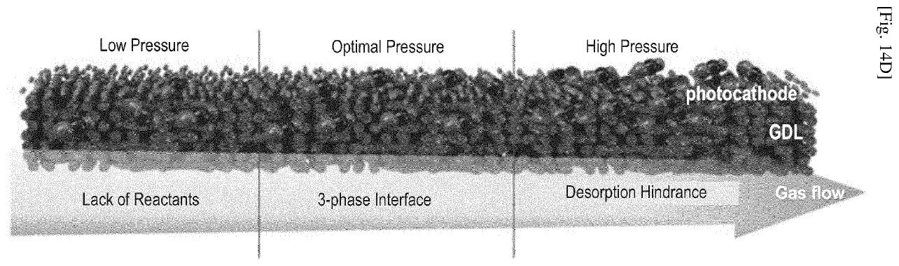

FIG. 14A is an example graph illustrating the effect of applied carbon dioxide gas flow rate on the production rate of carbon monoxide of the continuous flow photo-electric-catalytic reactor 1200. The graph of FIG. 14A shows results of experiments that varied feed flow rate and applied voltage. The experiments included testing of the following feed flow rates: 1 mL/min, 5 mL/min, 10 mL/min, 15 mL/min, and 20 mL/min. The experiments included testing of the following applied voltages: −0.1 V vs. RHE, −0.2 V vs. RHE, −0.3 V vs. RHE, and −0.4 V vs. RHE. The error bars shown in the graph of FIG. 14A signify the standard deviations from 3 replicated experiments. In these experiments, the optimum productivity was at a gas flow rate of 10 mL/min and an applied voltage of −0.4 V vs. RHE.

FIG. 14B is an example graph illustrating the effect of pressure of the applied carbon dioxide gas on the production rate of the continuous flow photo-electric-catalytic reactor 1200. The graph of FIG. 14B shows results of experiments that varied feed pressure and applied voltage. The experiments included testing of the following feed pressures: 1.1 bar, 1.2 bar, 1.3 bar, and 1.4 bar. The experiments included testing of the following applied voltages: −0.1 V vs. RHE, −0.2 V vs. RHE, −0.3 V vs. RHE, and −0.4 V vs. RHE. The error bars shown in the graph of FIG. 14B signify the standard deviations from 3 replicated experiments. In these experiments, the optimum productivity was at a feed pressure of 1.2 bar and an applied voltage of −0.4 V vs. RHE.

FIG. 14C is a schematic diagram illustrating the effect of applied carbon dioxide gas flow rate on a surface of the photocathode 1206 of the continuous flow photo-electric-catalytic reactor 1200. In FIG. 14C, the photo-electro-chemical catalyst 1292 and the GDL (for example, the microporous layer 1294 and macroporous layer 1296) of the photocathode 1206 are shown. For the low feed flow rate (left), there is low transport of carbon dioxide from the feed stream through the GDL, which can hinder productivity. For the optimal feed flow rate (middle), the photocathode 1206 experiences desorption acceleration, which can improve productivity. For the fast feed flow rate (right), the photocathode 1206 experiences short retention time of carbon dioxide from the feed stream, which can hinder the rate of lysis of carbon dioxide for producing carbon monoxide, thereby hindering productivity.

FIG. 14D is a schematic diagram illustrating the effect of pressure of the applied carbon dioxide gas on a surface of the photocathode 1206 of the continuous flow photo-electric-catalytic reactor 1200. In FIG. 14D, the photo-electro-chemical catalyst 1292 and the GDL (for example, the microporous layer 1294 and macroporous layer 1296) of the photocathode 1206 are shown. For the low feed pressure (left), there is a lack of reactant (carbon dioxide) from the feed stream, which can hinder productivity. For the optimal feed pressure (middle), the photocathode 1206 experiences a 3-phase interphase for optimal productivity. For the high feed pressure (right), the photocathode 1206 experiences desorption hindrance, which can hinder productivity.

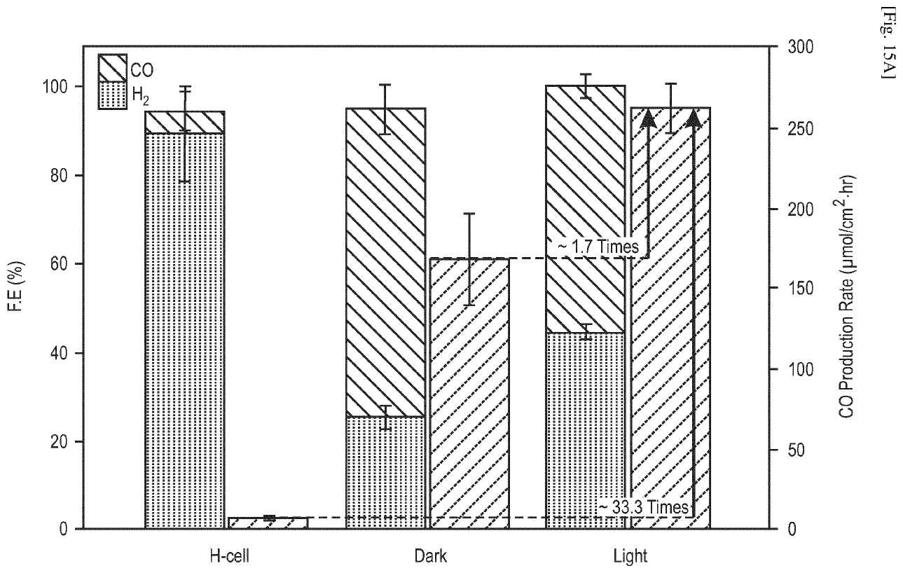

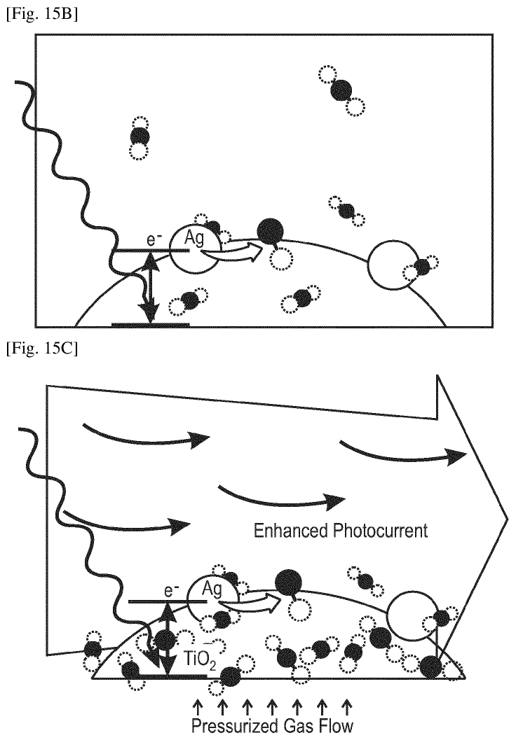

FIG. 15A is an example graph comparing faradaic efficiency and carbon monoxide production rates of an example hydrogen cell and an example of the continuous flow photo-electric-catalytic reactor 1200 with and without light irradiation. The graph of FIG. 15A shows results of experiments that tested the productivity (carbon monoxide production) of an example hydrogen cell (H-cell) (left), an implementation of the reactor 1200 without light shining onto the photocathode 1206 (middle), and an implementation of the reactor 1200 with light shining onto the photocathode 1206 (right). The left y-axis (left bars) is faradaic efficiency in percent (%). The right y-axis (right bars) is carbon monoxide production rate in micromoles per square centimeter per hour (μmol/cm2·hr). The error bars shown in the graph of FIG. 15A signify the standard deviations from 3 replicated experiments. In these experiments, the implementation of the reactor 1200 with light shining onto the photocathode 1206 exhibited the highest production of carbon monoxide. The implementation of the reactor 1200 with light shining onto the photocathode 1206 produced carbon monoxide at a rate of about 33.3 times that of the hydrogen cell. The implementation of the reactor 1200 with light shining onto the photocathode 1206 produced carbon monoxide at a rate of about 1.7 times that of the implementation of the reactor 1200 without light shining onto the photocathode 1206.

FIG. 15B is a schematic diagram illustrating the reaction environment of an example hydrogen cell, and FIG. 15C is a schematic diagram illustrating the reaction environment of an example of the continuous flow photo-electric-catalytic reactor 1200. The photocurrent imparted by the light shining on the photocathode 1206 and the voltage applied across the photocathode 1206 enhances the interaction of carbon dioxide from the feed stream with the photocathode 1206, thereby improving carbon monoxide production. As described in FIG. 14D, pressurizing the feed stream can also improve carbon monoxide production.

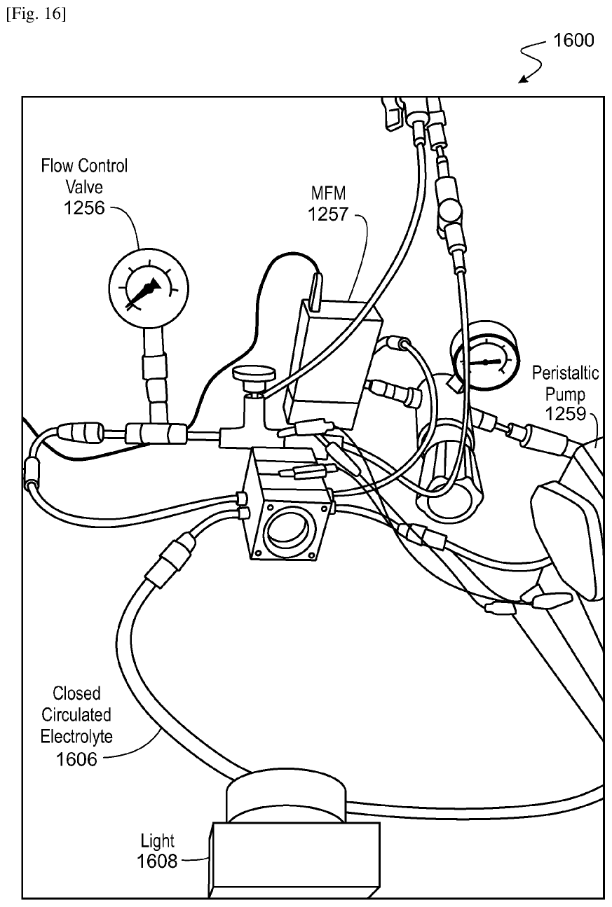

FIG. 16 is a schematic diagram 1600 of auxiliary components of an example of the continuous flow photo-electric-catalytic reactor 1200. As described previously, the gas control valve 1256 controls the flow rate of gas exiting the gas flow plate 1204, and the mass flowmeter (MFM) 1257 measures a mass flow rate of the gas exiting the gas flow plate 1204. The liquid flow controller 1259 circulates the electrolyte stream 1606 through the electrolyte flow plate 1214. In the example shown in FIG. 16, the liquid flow controller 1259 is a peristaltic pump. Light source 1608 shines light into the reactor 1200. The light from the light source 1608 shines through aperture(s) of the reactor 1200 and onto the photocathode 1206 disposed within the reactor 1200 as the feed stream and the electrolyte stream 1606 flow through the reactor 1200.

Although the subject matter has been described in terms of specific items, the limited implementations and the drawings, they are only provided to help more general understanding of the disclosure, and the subject matter is not limited to the above implementations. It will be appreciated by one skilled in the art to which the present disclosure pertains that various modifications and changes may be made from the above description.

Therefore, the spirit of the present disclosure shall not be limited to the above-described implementations, and the entire scope of the appended claims and their equivalents will fall within the scope and spirit of the disclosure.

1. A photocatalytic reactor comprising:
a first cell comprising a gas inlet and a gas outlet;
a second cell comprising an electrolyte inlet and an electrolyte outlet;
a reaction unit interposed between the first cell and the second cell and comprising a gas diffusion layer on which a photocatalyst is supported; and
a light source.

2. The photocatalytic reactor according to claim 1, wherein in the first cell, a raw material gas is supplied through the gas inlet, and a product gas is discharged through the gas outlet.

3. The photocatalytic reactor according to claim 1, wherein in the second cell, the electrolyte inlet and the electrolyte outlet are connected through a closed loop, so an electrolyte is continuously supplied to the second cell.

4. The photocatalytic reactor according to claim 1, wherein the light source is located on one side of the second cell so as to face the gas diffusion layer of the reaction unit.

5. The photocatalytic reactor according to claim 1, wherein the photocatalyst is supported on a surface facing the second cell so as to be in contact with an electrolyte in the second cell.

6. The photocatalytic reactor according to claim 1, wherein the gas diffusion layer comprises a hydrophobic membrane.

7. The photocatalytic reactor according to claim 6, wherein the hydrophobic membrane is a porous hydrophobic membrane.

8. The photocatalytic reactor according to claim 6, wherein the hydrophobic membrane is a porous polymer membrane or a porous ceramic membrane.

9. The photocatalytic reactor according to claim 1, wherein a gas in the first cell diffuses into the gas diffusion layer, and the diffused gas is converted into a product gas through the photocatalyst in contact with an electrolyte.

10. The photocatalytic reactor according to claim 1, wherein the first cell has a higher pressure than that in the second cell.

11. The photocatalytic reactor according to claim 2, wherein the raw material gas comprises carbon dioxide.

12. The photocatalytic reactor according to claim 2, wherein the product gas comprises carbon monoxide.

13. The photocatalytic reactor according to claim 1, wherein the light source irradiates light having an ultraviolet wavelength.

14. A method for photochemical continuous conversion of gas, the method comprising:
continuously supplying a raw material gas through a gas inlet of a first cell;
continuously supplying an electrolyte through an electrolyte inlet of a second cell; and
irradiating light to a gas diffusion layer on which a photocatalyst is supported, through one side of the second cell.

15. The method for photochemical continuous conversion of gas according to claim 14, wherein in the second cell, the electrolyte is discharged through an electrolyte outlet and then re-supplied to the second cell through the electrolyte inlet via a closed loop.

16. The method for photochemical continuous conversion of gas according to claim 14, or wherein in the first cell, the raw material gas is converted into a product gas, which is then discharged through a gas outlet located on one side of the first cell.

17. An apparatus comprising:
a photocathode comprising a photo-electro-chemical catalyst;
a gas flow plate configured to receive a feed stream comprising carbon dioxide, wherein the gas flow plate defines a first aperture, wherein the photocathode is disposed on the gas flow plate covering the first aperture, wherein the first aperture allows the feed stream to come in contact with the photocathode;
an anode, wherein the photocathode and the anode are cooperatively configured to apply a voltage across the photo-electro-chemical catalyst in response to receiving an electric current;
an electrolyte flow plate configured to receive an electrolyte stream comprising an aqueous solution of dissolved salt, wherein the electrolyte flow plate defines a second aperture aligned with the first aperture of the gas flow plate, wherein the second aperture allows the electrolyte stream to come in contact with the photocathode, wherein the photocathode is disposed intermediate of the first aperture of the gas flow plate and the second aperture of the electrolyte flow plate; and
a window disposed on the electrolyte flow plate covering the second aperture opposite of the photocathode, wherein the window is configured to prevent leakage of the electrolyte stream out of the second aperture of the electrolyte flow plate while allowing light from a light source to shine through the second aperture and onto the photocathode, wherein the photo-electro-chemical catalyst is configured to lyse the carbon dioxide to produce carbon monoxide in response to the feed stream contacting the photocathode, the electrolyte stream contacting the photocathode, the anode and the photocathode applying the voltage across the photo-electro-chemical catalyst, and the light source shining light onto the photocathode.

18. The apparatus according to claim 17, comprising a gas flow control valve configured to adjust a flow rate of a product gas exiting the gas flow plate, wherein the product gas comprises the produced carbon monoxide.

19. The apparatus according to claim 18, comprising a mass flowmeter configured to measure a mass flow rate of the product gas exiting the gas flow plate, wherein the gas flow control valve is communicatively coupled to the mass flowmeter and configured to adjust the flow rate of the product gas exiting the gas flow plate at least based on the mass flow rate of the product gas measured by the mass flowmeter.

20. The apparatus according to claim 18, or comprising a gas chromatography meter configured to determine a composition of the product gas exiting the gas flow plate, wherein the gas flow control valve is communicatively coupled to the gas chromatography meter and configured to adjust the flow rate of the product gas exiting the gas flow plate at least based on the composition of the product gas determined by the gas chromatography meter.

21. The apparatus according to claim 18, comprising a pump configured to circulate the electrolyte stream through the electrolyte flow plate.

22. A method comprising:
flowing a feed stream comprising carbon dioxide into a gas flow plate;
flowing an electrolyte stream comprising an aqueous solution of dissolved salt into an electrolyte flow plate, wherein a photocathode comprising a photo-electro-chemical catalyst is disposed intermediate of the gas flow plate and the electrolyte flow plate, wherein flowing the feed stream into the gas flow plate and flowing the electrolyte stream into the electrolyte flow plate cause the feed stream and the electrolyte stream to come into contact with the photocathode at opposite sides of the photocathode;
applying a voltage across the photo-electro-chemical catalyst;
directing light onto the photo-electro-chemical catalyst; and
lysing, by the photo-electro-chemical catalyst, the carbon dioxide of the feed stream to produce carbon monoxide in response to the feed stream contacting the photocathode, the electrolyte stream contacting the photocathode, the voltage applied across the photo-electro-chemical catalyst, and the light directed onto the photo-electro-chemical catalyst.

23. The method according to claim 22, comprising measuring a flow rate of a product gas exiting the gas flow plate, wherein the product gas comprises the produced carbon monoxide.

24. The method according to claim 23, comprising determining a composition of the product gas exiting the gas flow plate.

25. The method according to claim 24, comprising adjusting the flow rate of the product gas exiting the gas flow plate based on at least one of the measured flow rate or the determined composition.

26. The method according to claim 22, comprising circulating the electrolyte stream exiting the electrolyte flow plate back into the electrolyte flow plate.
